(19) United States
(12) Patent Application Publication
(10) Pub. No.: US 2010/0116361 A1
(43) Pub. Date: May 13, 2010

(54) FUEL PUMP CONTROL DEVICE FOR FUEL SUPPLY SYSTEM

(75) Inventors: Daiji FURUHASHI, Chiryu-city (JP); Kiyoshi Nagata, Nagoya-city (JP); Katsuhiko Nakabayashi, Handa-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/613,099

(22) Filed: Nov. 5, 2009

(30) Foreign Application Priority Data
Nov. 7, 2008 (JP) 2008-287105

(51) Int. Cl. F16K 31/20

(52) U.S. Cl. 137/398

(57) ABSTRACT

A fuel pump control device is for a fuel supply system for an engine. The system includes a fuel tank, a subtank, a fuel pump pumping fuel in the subtank for supply to the engine, a pressure regulator regulating fuel pressure from the fuel pump within a set pressure, and a jet pump pumping fuel in the fuel tank into the subtank through pumping action by a fuel ejection flow to the fuel tank through a return pipe of the regulator. The device includes a fuel level detecting unit for detecting fuel tank level and a control unit for controlling fuel discharge amount from the fuel pump. The control unit sets jet pump drive correction amount of fuel for driving the jet pump based on the fuel tank level. The control unit increases the fuel discharge amount from the fuel pump by the correction amount to drive the jet pump.

### CROSS REFERENCE TO RELATED APPLICATION

This application is based on and incorporates herein by reference Japanese Patent Application No. 2008-287105 filed on Nov. 7, 2008.

### BACKGROUND OF THE INVENTION

1. Field of the Invention

The present invention relates to a fuel pump control device for a fuel supply system, which includes a subtank in a fuel tank for storing fuel intensively when an amount of remaining fuel becomes small, and which pumps up fuel in the subtank by a fuel pump so as to supply the fuel to an internal combustion engine (engine).

2. Description of Related Art

A fuel supply system of the above-described kind, as described in JP-A-2008-248736 (corresponding to US2008/0236676A1), or JP-A-07-304340, for example, includes a jet pump for pumping up fuel in a fuel tank into a subtank, and suctions fuel in the fuel tank into the jet pump by negative pressure generated in the jet pump so that fuel flows into the subtank. This negative pressure is generated in the jet pump by ejecting the fuel, which is returned into the fuel tank through a return pipe of a pressure regulator provided on a discharge side of a fuel pump, to an introduction port of the jet pump.

According to the control of a conventional fuel pump, a fuel pump is driven with a constant rotating speed, and fuel is supplied to an injector with the pressure of fuel, which is discharged from the fuel pump at a constant discharge rate, being regulated at a preset fuel pressure by a pressure regulator. Furthermore, excessive fuel having more than the preset fuel pressure is supplied to a jet pump through a return pipe of the pressure regulator. Based on this relationship, the discharge rate of the fuel pump is set such that the fuel pump is capable of supplying at least a maximum fuel consumption amount of an engine and a fuel amount for driving the jet pump.

Conventionally, even though an amount of remaining fuel in the fuel tank is large, the discharge rate of the fuel pump is controlled such that the return fuel is supplied to the jet pump from the pressure regulator so as to pump up the fuel in the fuel tank into the subtank by the jet pump. However, when a fuel level of the fuel tank is higher than an upper opening of the subtank, fuel in the fuel tank flows spontaneously into the subtank over the upper opening of the subtank, so that the subtank is filled with fuel. Therefore, fuel need not be supplied to the jet pump from the pressure regulator. For this reason, when an amount of remaining fuel in the fuel tank is large, fuel continues being wastefully supplied to the jet pump. The fuel pump continues to wastefully consume excessive electric power accordingly, so that fuel consumption deteriorates.

### SUMMARY OF THE INVENTION

The present invention addresses the above disadvantages. Thus, it is an objective of the present invention to provide a fuel pump control device for a fuel supply system having a jet pump for pumping up fuel in a fuel tank into a subtank. The fuel pump control device limits a regular discharge amount of a fuel pump so as to improve fuel consumption.

To achieve the objective of the present invention, there is provided a fuel pump control device for a fuel supply system for an internal combustion engine. The system includes a fuel tank, a subtank, a fuel pump, a pressure regulator, and a jet pump. The subtank is disposed in the fuel tank such that fuel in the fuel tank flows into the subtank over an upper opening of the subtank when a fuel level in the fuel tank is higher than the upper opening of the subtank. The fuel pump is configured to pump up fuel in the subtank so as to supply fuel to the engine. The pressure regulator is configured to regulate pressure of fuel that is discharged from the fuel pump within a set pressure. The jet pump is configured to pump up fuel in the fuel tank into the subtank through pumping action generated by an ejection flow of fuel returned into the fuel tank through a return pipe of the pressure regulator. The device includes a fuel level detecting means and a control means. The fuel level detecting means is for detecting the fuel level in the fuel tank. The control means is for controlling a discharge amount of fuel from the fuel pump. The control means sets a jet pump drive correction amount of fuel for driving the jet pump based on the fuel level in the fuel tank detected by the fuel level detecting means. The control means increases the discharge amount of fuel from the fuel pump by the jet pump drive correction amount so as to drive the jet pump.

### BRIEF DESCRIPTION OF THE DRAWINGS

The invention, together with additional objectives, features and advantages thereof, will be best understood from the following description, the appended claims and the accompanying drawings in which:

FIG. 1A is a diagram illustrating a constitution of a fuel supply system in accordance with an embodiment of the invention in a state where an amount of remaining fuel in a fuel tank is large;

FIG. 1B is a diagram illustrating the constitution of the fuel supply system in accordance with the embodiment in a state where the amount of remaining fuel in the fuel tank is small;

FIG. 2 is a block diagram illustrating a constitution of a control system in accordance with the embodiment;

FIG. 3 is a flow chart illustrating a flow of processing of a target rotation speed calculation routine in accordance with the embodiment;

FIG. 4 is a diagram conceptually illustrating an example of a map for calculating a jet pump drive correction amount with a fuel level in the fuel tank as a parameter in accordance with the embodiment; and

FIG. 5 is a diagram conceptually illustrating a two-dimensional map for calculating a target rotation speed with a target discharge amount and fuel pressure as parameters in accordance with the embodiment.

### DETAILED DESCRIPTION OF THE INVENTION

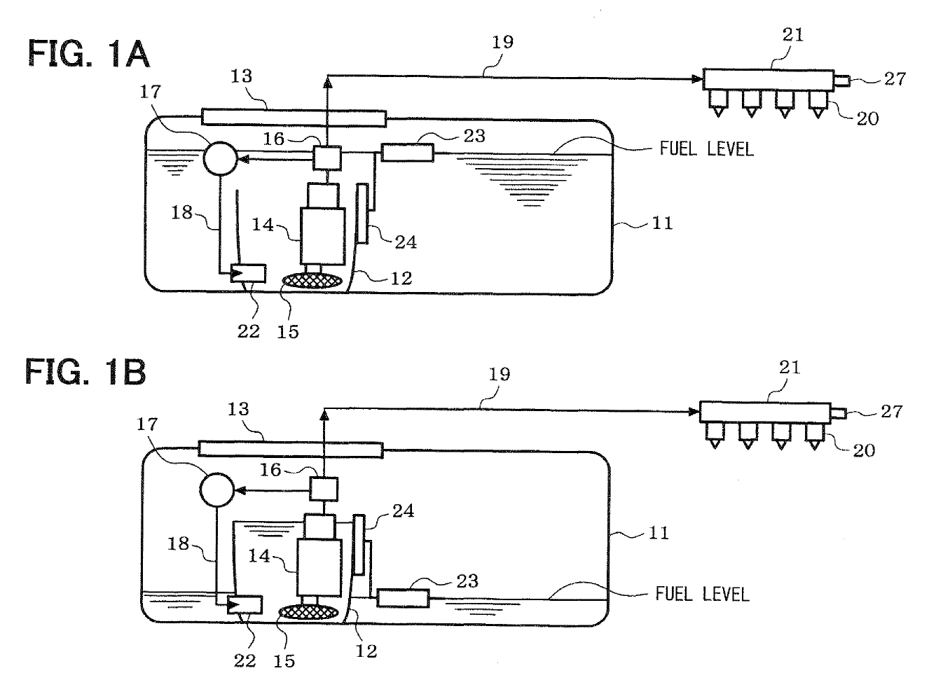

An embodiment of the invention is described below referring to the accompanying drawings. An overall constitution of a fuel supply system is roughly described with reference to FIG. 1A and FIG. 1B. As shown in FIG. 1B, a subtank 12 for storing fuel intensively by a jet pump 22, which is described in greater detail hereinafter, when an amount of remaining fuel in a fuel tank 11 is small, is disposed in the fuel tank 11. A flange 13 for supporting the subtank 12 via an elastic material such as a spring is attached to the fuel tank 11. As shown in FIG. 1A, when a fuel level of the fuel tank 11 is higher than an upper opening of the subtank 12, fuel in the fuel tank 11 flows into the subtank 12 over the upper opening of the subtank 12, so that the subtank 12 is filled with fuel.

A fuel pump 14 is provided in the subtank 12, and a suction filter 15 is attached to a suction opening of the fuel pump 14. A fuel filter 16 for filtering fuel discharge from the fuel pump 14, and a pressure regulator 17 for regulating the pressure of fuel discharged from the fuel pump 14 so as not to exceed a set pressure, are disposed on a discharge port side of the fuel pump 14. A return pipe 18 for returning surplus fuel having more than the set pressure into the fuel tank 11 is connected to the pressure regulator 17.

The fuel which has been filtered through the fuel filter 16 is supplied to a delivery pipe 21 through a fuel pipe 19, and then distributed to an injector 20 of each cylinder of an engine (internal combustion engine) in the delivery pipe 21. Accordingly, the fuel is injected into an intake port of each cylinder through the injector 20 with a fuel injection quantity (injection period) that is set in accordance with an engine operating state. A fuel pressure sensor 27 for detecting fuel pressure is attached to the delivery pipe 21.

A jet pump 22 for supplying fuel in the fuel tank 11 into the subtank 12 is attached to a lower part of the subtank 12, and the return pipe 18 of the pressure regulator 17 is connected to an introduction port of the jet pump 22. Because of the above-described constitution, the fuel discharged from the return pipe 18 is ejected to the introduction port of the jet pump 22, so that negative pressure (pump action) is generated in the jet pump 22. Fuel in the fuel tank 11 is suctioned into the jet pump 22 due to this negative pressure so as to flow into the subtank 12. As a result, as shown in FIG. 1B, even when an amount of remaining fuel in a fuel tank 11 is small or even when a fluid level of fuel in the fuel tank 11 is tilted greatly (e.g., when a vehicle whirls round, or when a vehicle body is inclined), a fuel level of the subtank 12 is kept higher than the suction opening of the fuel pump 14, so that the fuel pump 14 stably suctions fuel in the subtank 12.

A float 23 floating on a fluid level of fuel in the fuel tank 11 (i.e., outside the subtank 12), and a fuel level gauge 24 (fuel level detecting means) for measuring a height position of the float 23 as the fuel level of the fuel tank 11 (amount of remaining fuel), are arranged outside the subtank 12.

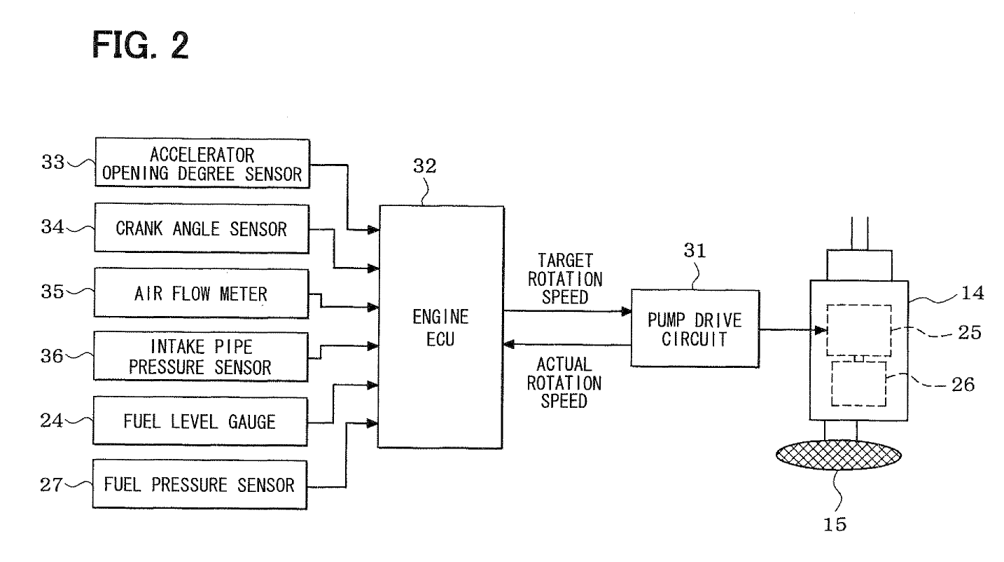

As shown in FIG. 2, the fuel pump 14 is configured such that a pump part 26 is driven by a brushless motor 25, and a sensorless brushless motor is used as the brushless motor 25. The reason to use the sensorless brushless motor 25 is that it is difficult to ensure reliability of a position detecting sensor such as a Hall element for detecting a rotational position of a rotor since the brushless motor 25 of the fuel pump 14 is immersed in fuel. If this problem is solved, however, a brushless motor having a sensor such as a Hall element obviously may be used.

The brushless motor 25 in the fuel pump 14 is driven by a pump drive circuit 31. The pump drive circuit 31 is incorporated in the fuel pump 14. Alternatively, the circuit 31 may be disposed outside the fuel pump 14 or outside the fuel tank 11. A feedback control circuit part (feedback control means) for feedback-controlling an actual rotation speed of the fuel pump 14 to be a target rotation speed and a drive circuit part (inverter circuit) for driving the brushless motor 25 based on an output of this feedback control circuit are provided in a pump drive circuit 31. The control of the rotation speed of the brushless motor 25 of the fuel pump 14 by the pump drive circuit 31/may be performed/by a widely known rotation speed control method, for example, by a PWM (Pulse Width Modulation) method such as described in JP-A-2000-341982.

The pump drive circuit 31 receives a signal of the target rotation speed of the fuel pump 14 which is transmitted from an engine ECU 32 (engine electronic control unit) for controlling operation of the engine, and transmits to the engine ECU 32 a signal of the actual rotation speed of the fuel pump 14 detected in the pump drive circuit 31. The pump drive circuit 31 of the present embodiment is constituted of a hardware circuitry. Alternatively, the pump drive circuit 31 may be constituted so as to realize the function of feedback control using software.

The engine ECU 32 reads signals from various sensors for detecting the engine operating state, such as an accelerator opening degree sensor 33 for detecting an accelerator opening degree (accelerator operation amount), a crank angle sensor 34 for detecting, for example, an engine rotation speed, an air flow meter 35 for detecting an amount of suction air, an intake pipe pressure sensor 36 for detecting intake pipe pressure, and the fuel pressure sensor 27, so as to control, for example, fuel injection quantity or ignition timing of the injector 20 in accordance with the engine operating state.

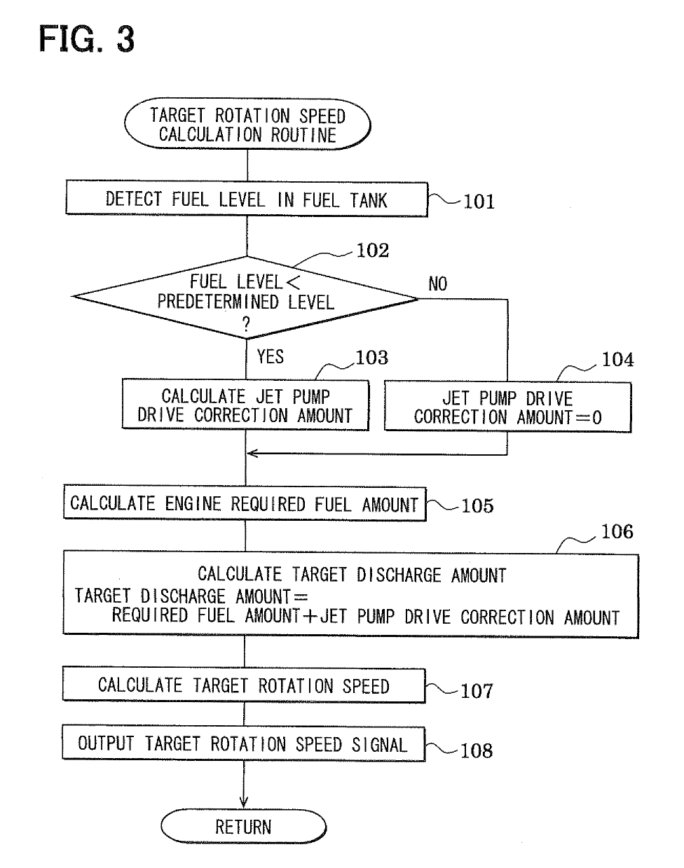

Furthermore, the engine ECU 32 functions as a “control means” for controlling a discharge amount from the fuel pump 14 by executing a target rotation speed calculation routine in FIG. 3, which is described in greater detail hereinafter. When correcting the discharge amount from the fuel pump 14 to increase for driving the jet pump 22, the engine ECU 32 sets an increase correction amount (hereinafter referred to as a “jet pump drive correction amount”) for driving the jet pump 22 based on the fuel level of the fuel tank 11 detected by the fuel level gauge 24. The engine ECU 32 calculates a target discharge amount through the correction using the jet pump drive correction amount by adding the jet pump drive correction amount to a required fuel amount of the engine, so as to calculate the target rotation speed based on the target discharge amount. Then, the engine ECU 32 obtains the target rotation speed which is corrected in accordance with the jet pump drive correction amount, and transmits a signal of the target rotation speed to the pump drive circuit 31. The engine ECU 32 feedback-controls the pump drive circuit 31 to decrease a difference between the actual rotation speed and the target rotation speed of the fuel pump 14. Processing of the target rotation speed calculation routine illustrated in FIG. 3 executed by the engine ECU 32 is described below.

The target rotation speed calculation routine of FIG. 3 is executed repeatedly with a predetermined period by the engine ECU 32 while the engine is in operation. When this routine is started, the engine ECU 32 first reads the fuel level of the fuel tank 11 detected by the fuel level gauge 24 at Step 101. After this, control proceeds to Step 102 to determine whether the level of fuel in the fuel tank 11 is lower than a predetermined level thereby to determine whether there is a need to activate the jet pump 22 by supplying fuel to the jet pump 22 from the pressure regulator 17. In such a case, when the fuel level of the fuel tank 11 becomes lower than the upper opening of the subtank 12, fuel in the fuel tank 11 does not flow into the subtank 12 over the upper opening of the subtank 12. Therefore, a lower limit fuel level (predetermined level) where the jet pump drive correction amount is 0 (zero) may be set, for example, at a fuel level close to the upper opening of the subtank 12. In addition, in view of inclination of the fluid level of fuel in the fuel tank 11 when the vehicle travels along a hill (i.e., when the vehicle body is inclined) or when the vehicle whirls round, the lower limit fuel level may be set at a fuel level which is a little higher than the upper opening of the subtank 12.

If it is determined at Step 102 that the level of fuel in the fuel tank 11 is lower than the predetermined level, it is determined that there is a need to activate the jet pump 22 by supplying fuel to the jet pump 22 from the pressure regulator 17, so that control proceeds to Step 103 to calculate the jet pump drive correction amount for supplying fuel to the jet pump 22. The jet pump drive correction amount may be set at a constant value, or the jet pump drive correction amount may be varied according to the fuel level of the fuel tank 11. For example, the jet pump drive correction amount (discharge amount from the fuel pump 14) may be further increased within a controllable range of the fuel pump 14, as the fuel level in the fuel tank 11 becomes lower.

If it is determined at Step 102 that the level of fuel in the fuel tank 11 is equal to or higher than the predetermined level, it is determined that there is no need for the supply of fuel to the jet pump 22 from the pressure regulator 17, and then control proceeds to Step 104 to set the jet pump drive correction amount at 0 (or minimum value).

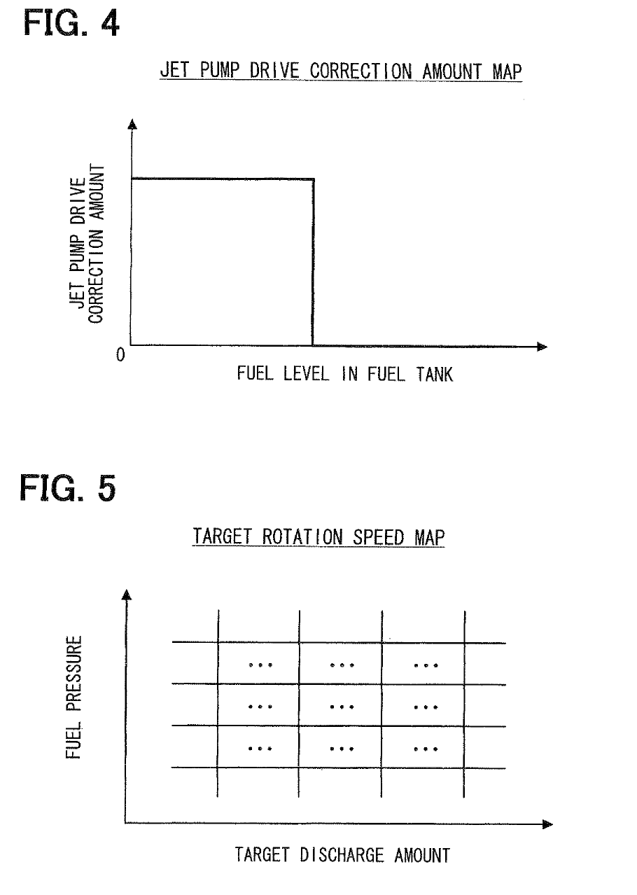

Additionally, instead of the processing at Steps 102 to 104 described above, a map illustrated in FIG. 4 for calculating the jet pump drive correction amount with the fuel level in the fuel tank 11 as a parameter may be stored in a read-only memory (ROM) of the engine ECU 32 in advance. The jet pump drive correction amount in accordance with the fuel level in the fuel tank 11 detected by the fuel level gauge 24 may be calculated using the jet pump drive correction amount map in FIG. 4. In the jet pump drive correction amount map in FIG. 4 as well, the jet pump drive correction amount may be set to be 0 (or minimum value) in a range in which the level of fuel in the fuel tank 11 is equal to or higher than the predetermined level.

Then, control proceeds to Step 105 to calculate the required fuel amount of the engine using the following equation:

(required fuel amount)=[injection quantity of the injector 20]×[engine rotation speed/2]×(number of cylinders)

At the following Step 106, the target discharge amount after the correction using the jet pump drive correction amount is obtained by adding the jet pump drive correction amount to the required fuel amount of the engine.

(target discharge amount)=(required fuel amount)+(jet pump drive correction amount)

After that, control proceeds to Step 107 to calculate the target rotation speed in accordance with the target discharge amount after the estimation correction and the fuel pressure, with reference to a two-dimensional map illustrated in FIG. 5 for calculating the target rotation speed of the fuel pump 14 with the target discharge amount and the fuel pressure as parameters. Through the execution of the above-described processing, the target rotation speed that is corrected in accordance with the jet pump drive correction amount is obtained.

Lastly, at the following Step 108, a signal of the target rotation speed is outputted to the pump drive circuit 31 from the engine ECU 32. Accordingly, the pump drive circuit 31 performs the feedback control to make the actual rotation speed of the fuel pump 14 coincide with the target rotation speed.

In the present embodiment described above, when the level of fuel in the fuel tank 11 is equal to or higher than the predetermined level (i.e., when fuel in the fuel tank 11 flows spontaneously into the subtank 12 over the upper opening of the subtank 12), it is determined that there is no need for the supply of fuel to the jet pump 22 from the pressure regulator 17. As a result, the control for reducing a regular discharge amount from the fuel pump 14 compared to the conventional fuel pump by setting the jet pump drive correction amount at 0 (or a small value; or a minimum value) is achieved. Therefore, power consumption of the fuel pump 14 is reduced, and fuel efficiency is improved.

In addition, according to the target rotation speed calculation routine of FIG. 3, by adding the jet pump drive correction amount corrected in accordance with the fuel level of the fuel tank 11 to the engine required fuel amount, the target discharge amount with correction by the jet pump drive correction amount is obtained. Then, the target rotation speed is calculated based on this target discharge amount. Alternatively, for example, the target rotation speed of the fuel pump 14 may be directly calculated based on the engine required fuel amount or a parameter (e.g., fuel injection quantity of the injector 20, engine rotation speed, or engine load) correlating with this. Then, in accordance with the fuel level of the fuel tank 11, the jet pump drive correction amount is set with respect to the target rotation speed. Using this jet pump drive correction amount, estimation correction may be directly made on the target rotation speed.

Moreover, the constitution of the fuel supply system to which the invention is applicable is not limited to that of FIG. 1A and FIG. 1B, and the invention may be applied to and embodied in fuel supply systems having various constitutions with a subtank and a jet pump.

Additional advantages and modifications will readily occur to those skilled in the art. The invention in its broader terms is therefore not limited to the specific details, representative apparatus, and illustrative examples shown and described.

What is claimed is:

1. A fuel pump control device for a fuel supply system for an internal combustion engine, the system including:
a fuel tank;
a subtank disposed in the fuel tank such that fuel in the fuel tank flows into the subtank over an upper opening of the subtank when a fuel level in the fuel tank is higher than the upper opening of the subtank;
a fuel pump configured to pump up fuel in the subtank so as to supply fuel to the engine;
a pressure regulator configured to regulate pressure of fuel that is discharged from the fuel pump within a set pressure; and
a jet pump configured to pump up fuel in the fuel tank into the subtank through pumping action generated by an ejection flow of fuel returned into the fuel tank through a return pipe of the pressure regulator, the device comprising:
a fuel level detecting means for detecting the fuel level in the fuel tank; and
a control means for controlling a discharge amount of fuel from the fuel pump, wherein:
the control means sets a jet pump drive correction amount of fuel for driving the jet pump based on the fuel level in the fuel tank detected by the fuel level detecting means; and
the control means increases the discharge amount of fuel from the fuel pump by the jet pump drive correction amount so as to drive the jet pump.

2. The fuel pump control device according to claim 1, wherein the control means sets the jet pump drive correction amount at 0 when the fuel level in the fuel tank detected by the fuel level detecting means is equal to or higher than a predetermined level.
